(19) United States
(12) Patent Application Publication
(10) Pub. No.: US 2022/0111611 A1
(43) Pub. Date: Apr. 14, 2022

(54) Method and System for Preparing Blanks for Forming Cartons

(71) Applicant: Graphic Packaging International, LLC, Atlanta, GA (US)

(72) Inventors: Joseph C. Walsh, Boulder, CO (US); Jeffrey T. Sloat, Broomfield, CO (US)

(21) Appl. No.: 17/500,991

(22) Filed: Oct. 14, 2021

Related U.S. Application Data
(60) Provisional application No. 63/091,823, filed on Oct. 14, 2020.

(51) Int. Cl. B31B 50/74; B05C 1/02; B05C 13/02; B31B 50/04; B31B 50/00; B31B 50/36

(52) U.S. Cl. CPC B31B 50/747; B05C 1/025; B05C 13/02; B31B 50/624; B31B 50/006; B31B 50/36; B31B 50/042

(57) ABSTRACT

A method of preparing a blank for forming a carton includes obtaining a blank, positioning the blank in a blank feeder assembly of a system for preparing blanks, moving the blank from the blank feeder assembly to a conveyor assembly of the system, and activating the conveyor assembly to move the blank along a coating applicator assembly of the system, the coating applicator assembly having a container defining a reservoir holding a volume of a coating and an applicator wheel rotatably supported at least partially in the reservoir of the coating applicator assembly. The method further includes applying a portion of the coating from the reservoir to a portion of the blank.

### CROSS-REFERENCE TO RELATED APPLICATION

This application claims the benefit of U.S. Provisional Patent Application No. 63/091,823, filed on Oct. 14, 2020.

### INCORPORATION BY REFERENCE

The disclosure of U.S. Provisional Patent Application No. 63/091,823, filed on Oct. 14, 2020, is hereby incorporated by references for all purposes as if presented herein in its entirety.

### BACKGROUND OF THE DISCLOSURE

The present disclosure generally relates to systems and methods of preparing or processing blanks for forming containers, trays, and/or other suitable constructs.

### SUMMARY OF THE DISCLOSURE

According to one aspect, the disclosure is generally directed to a method of preparing a blank for forming a carton, the method comprising obtaining a blank, positioning the blank in a blank feeder assembly of a system for preparing blanks, moving the blank from the blank feeder assembly to a conveyor assembly of the system, and activating the conveyor assembly to move the blank along a coating applicator assembly of the system, the coating applicator assembly comprising a container defining a reservoir holding a volume of a coating and an applicator wheel rotatably supported at least partially in the reservoir of the coating applicator assembly. The method further comprises applying a portion of the coating from the reservoir to a portion of the blank.

According to another aspect, a system for preparing blanks for forming cartons comprises a blank feeder assembly positioned proximate an upstream end of the system for distributing at least one blank therefrom, a conveyor assembly positioned downstream from the blank feeder assembly and comprising at least one blank engaging member for contacting and moving the at least one blank in a downstream direction of the system, and a coating applicator assembly positioned along a portion of the conveyor assembly, the coating applicator assembly comprising a container defining a reservoir holding a volume of a coating and an applicator wheel rotatably supported at least partially in the reservoir of the coating applicator assembly.

According to another aspect, the disclosure is generally directed to a coating applicator assembly for applying coating to at least one blank, the coating applicator assembly comprising a container defining a reservoir holding a volume of a coating, and an applicator wheel rotatably supported at least partially in the reservoir of the coating applicator assembly, the applicator wheel positioned for contacting at least one blank moving thereby to apply at least a portion of the coating in the reservoir to at least a portion of the at least one blank.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank for use with systems according to the present disclosure.

FIG. 2 is a perspective view of a system for preparing blanks for forming cartons according to a first exemplary embodiment of the disclosure.

FIG. 3 is a side view of the system of FIG. 2.

FIG. 4 is an enlarged perspective view of a portion of the system of FIG. 2.

FIG. 5 is an enlarged side view of a portion of the system of FIG. 2.

FIG. 6 is a perspective view of an alternative configuration of the system of FIG. 2.

FIG. 7 is an enlarged perspective view of a portion of the system illustrated in FIG. 6.

FIG. 8 is a perspective view of a system for preparing blanks for forming cartons according to a second exemplary embodiment of the disclosure.

FIG. 9 is a side view of the system of FIG. 8.

FIG. 10 is another side view of the system of FIG. 8.

FIG. 11 is an enlarged perspective view of a portion of the system of FIG. 8.

FIG. 12 is an isolated perspective view of a blank folding apparatus of the system of FIG. 8

FIG. 13 is an enlarged perspective view of another portion of the system of FIG. 8.

FIG. 14 is an enlarged perspective view of another portion of the system of FIG. 8.

FIG. 15 is a process diagram illustrating a method of preparing blanks with systems according to the present disclosure according to an exemplary embodiment.

Corresponding parts are designated by corresponding reference numbers throughout the drawings.

### DETAILED DESCRIPTION OF THE EXEMPLARY EMBODIMENTS

The present disclosure generally relates to a system and method of preparing/processing a blank or other construct for further processing and/or for forming cartons, containers, or other constructs for holding products such as personal care/toiletry items, or other articles. For example, the cartons could be used for holding bars or other configurations of soap and/or solid detergent.

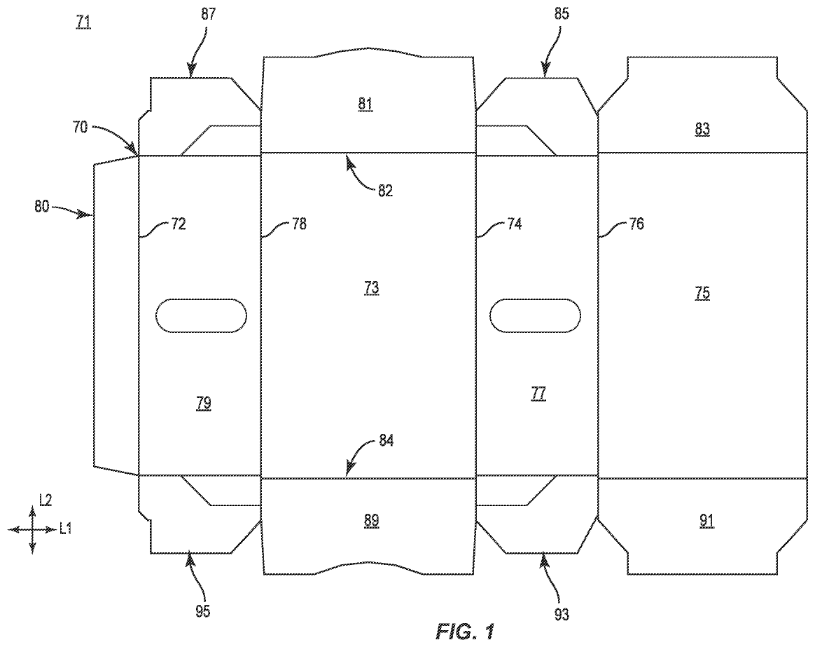

Referring initially to FIG. 1, an exterior surface 70 of a carton blank 71 that can be obtained for forming a carton or other construct is illustrated. As shown, the carton blank 71 has a longitudinal axis L1 and a lateral axis L2, and includes a top panel 73, a first side panel 77 foldably connected to the top panel 73 at a lateral fold line 74, a bottom panel 75 foldably connected to the side panel 77 at a lateral fold line 76, a second side panel 79 foldably connected to the top panel 73 at a lateral fold line 78, and an attachment flap 80 foldably connected to the second side panel 79 at a lateral fold line 72. As shown, the blank 71 also includes end flaps 81, 83, 85, 87 foldably connected to the panels 73, 75, 77, 79 at respective portions of a longitudinal fold line 82 for closing a first end of a carton formed from the blank 71 and second end flaps 89, 91, 93, 95 foldably connected to the panels 73, 75, 77, 79 at respective portions of a longitudinal fold line 84 for closing a second end of the carton formed from the blank 71.

In one embodiment, the blank 71 can be provided with a barrier coating that is suitable to minimize, inhibit, and/or prevent the passage of fluids such as product runoff, condensation, leakage, etc. therethrough. Such barrier coating can be provided so that the blank can have suitable barrier properties without the presence of a liner or other polymeric material applied thereto, e.g., to facilitate recyclability of the paperboard or other renewable material forming the blank 71.

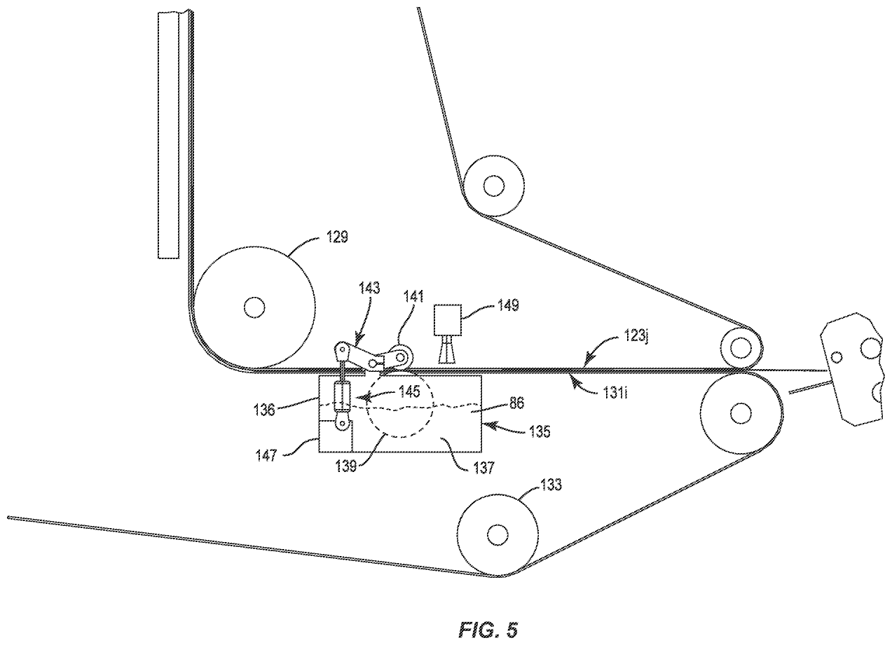

As described further herein, the blank 71 can be provided with an adhesive coating 86 (FIG. 5) disposed on at least a portion of the attachment flap 80 to facilitate formation of a carton from the blank 71. In one embodiment, the coating 86 can be a heat sealable fluid, e.g., so as to provide enhanced adhesive properties when exposed to a sufficient heat source.

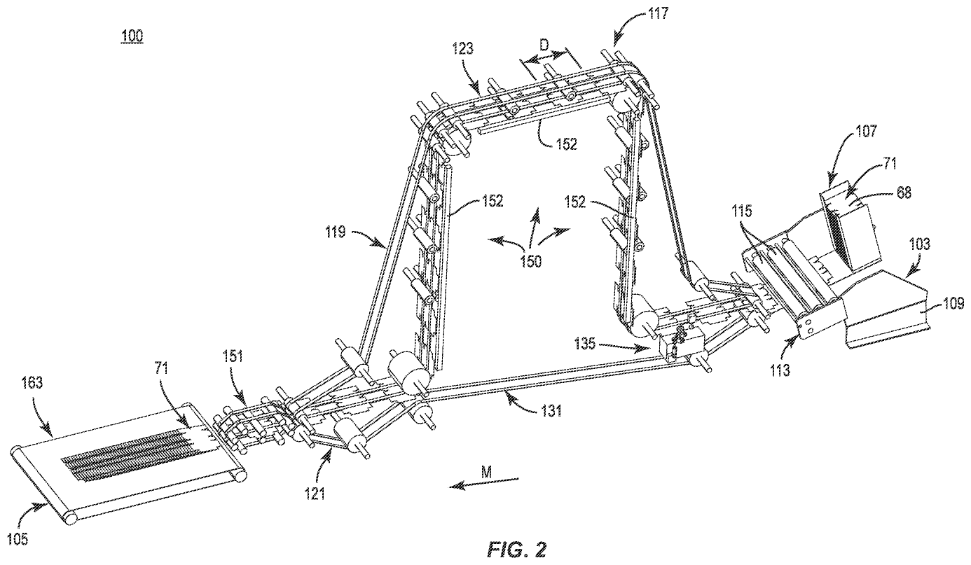

FIGS. 2-5 generally illustrate a first exemplary embodiment of a system 100 for preparing/processing blanks 71 in accordance with the present disclosure. As described herein, the system 100 can be configured to apply the coating 86 to at least a portion of the exterior surface 70 of one or more blanks 71 for further preparation/processing, e.g., folding and erection of the blanks 71 into cartons. In one embodiment, the system 100 can apply the coating 86 to the blanks 71 for forming a collapsed, e.g., flattened or knocked down, configuration of a carton for shipping to a customer.

Such a collapsed configuration of a carton formed from the blanks 71 can be provided with the coating 86 so as to avoid relatively thicker applications of adhesive such as glue that can be susceptible to formation of large globs or stickers that can interfere with transition of cartons formed from the blanks 71 from a collapsed configuration to an erected configuration. In one embodiment, a barrier coating on the blank 71 and the coating 86 can be selected from materials that provides one or more adhesive or adherable regions to the blanks 71 for formation of collapsed cartons that are free from polymeric material.

The blanks 71 can move through the system 100 from an upstream end 103 to a downstream end 105 thereof generally in a downstream direction or machine direction M that defines/is parallel to a downstream direction with regard to the system 100 and such that the blanks 71 are engaged by various portions and components of the system 100. In this regard, an upstream direction with regard to the system 100 is a direction opposite the machine direction M/downstream direction.

It will be understood that the components of the system 100 described herein can be supported on one or more frames, e.g., platforms, legs, struts, bars, platforms, casters, connecting portions thereof, etc.

The system 100 can include a blank feeder assembly 107 proximate the upstream end 103 thereof for receiving and sequentially distributing blanks 71 in the machine direction M of the system 100. As shown, the blank feeder assembly 107 can include a housing/base 109 that supports a blank infeed 110 for receiving one or more of the blanks 71. As shown, the blank infeed 110 can have a chute or hopper-like configuration for receiving stacked blanks 71.

A blank distribution mechanism can be positioned in communication with a bottom or exit end of the blank infeed 110. The distribution mechanism can be configured to engage and move one or more of the blanks 71 from the blank infeed 110 in the downstream direction M of the system 100. In this regard, the distribution mechanism can include a rotatable wheel, shuttle, movable plate, etc. operatively coupled with an actuator such as a drive shaft, piston, linkage, etc. In one embodiment, the blank distribution mechanism can include one or more suction members mounted on an actuator for engaging one or more blanks 71 via a vacuum or suction seal and moving the blanks 71 to a desired location, e.g., a pick-and-place mechanism.

As shown, an exit section 113 of the blank feeder assembly 107 can be positioned adjacent the distribution mechanism for receiving the blanks 71 output by the distribution mechanism and transferring the blanks 71 in the machine direction M of the system 100. The exit section 113 can include one or more rollers 115 for engaging, e.g., via rolling contact, the one or more blanks 71 exiting the distribution mechanism. In one embodiment, the rollers 115 can be provided in vertically-adjacent pairs, with the blanks 71 passing between respective pairs of rollers 115. In another embodiment, the rollers 115 can be positioned above a supporting surface, such as a bedplate, conveyor belt, etc. It will be understood that one or more of the rollers 115 can be driven by a drive shaft or other actuator, or can be configured to passively roll upon contact with the blanks 71, in one example, as the blanks 71 are gravity fed along a sloped or ramped path.

The exit section 113 of the blank feeder assembly 107 is positioned such that blanks 71 exiting the blank feeder assembly 107 are fed into a conveyor assembly 117. The conveyor assembly 117, as shown, includes an upper conveyor apparatus 119 and a lower conveyor apparatus 121.

The upper conveyor apparatus 119 can include a pair of parallel and spaced apart blank engaging members 123 having a generally elongate configuration, e.g., bands, belts, plates, rods, etc. It will be understood that one or both of the engaging members 123 can be continuous members, or can be formed of multiple jointed segments. In one embodiment, one or both of the engaging members 123 can be formed of a stretchable material, e.g., an elastomeric material or otherwise elastically deformable and/or resilient material.

The blank engaging members 123 of the upper conveyor apparatus 119, as shown, can be provided in an at least partially looped configuration about a plurality of rollers that include rollers 125, 127, 129 to form, in counterclockwise occurrence, generally upwardly oblique segments 123a, 123b, generally horizontal (e.g., parallel to the machine direction M/lateral axis L2) segment 123c, generally downwardly oblique segments 123d, 123e, generally horizontal segment 123f, generally vertical (e.g., perpendicular to the machine direction M and axes L1, L2) segment 123g, generally horizontal segment 123h, generally vertical segment 123i, and generally horizontal segment 123j.

Similarly, the lower conveyor apparatus 121 can include a pair of parallel and spaced apart blank engaging members 131 having a configuration generally similar to the engaging members 123 described above and arranged about a plurality of rollers that include rollers 125, 129 and 133 to form, in clockwise occurrence, generally downwardly oblique segment 131a, generally horizontal segment 131b, generally downwardly oblique segment 131c, generally upwardly oblique segment 131d, generally horizontal segment 131e, generally vertical segment 131f, generally horizontal segment 131g, generally vertically downward segment 131h, and generally horizontal segment 131i.

In this regard, and as shown, the segments 123j, 123i, 123h, and 123g of the engaging members 123 of the upper conveyor apparatus 119 are in overlapping, e.g., parallel and/or aligned, arrangement with the respective segments 131i, 131h, 131g, 131f, and 131e of the engaging members 131 of the lower conveyor apparatus 121. It will be understood that the respective engaging members 121, 131 can be in contact with one another at one or more portions, or, as described further herein, can be spaced apart either by predetermined alignment or the presence of one or more blanks 71 therebetween.

It will be understood that the upper conveyor apparatus 119 and the lower conveyor apparatus 121 can be selectively positioned and/or adjustable to provide a desired amount of spacing/tolerance between respective segments of the engaging members 123, 131, e.g., to provide a desired clearance or compression between respective overlapping engaging members 123, 131. It will be further understood that the rollers 125, 127, 129, and 133 can be supported and/or adjustable to relative spacing/tolerance so as to change or maintain a desired amount of tension on the engaging members 123, 131.

In addition, one or more of the rollers 125, 127, 129, 133 can be driven by a drive shaft or other actuator, or can be configured to passively roll. In this regard, one or more of the rollers 125, 127, 129 associated with the upper conveyor apparatus 119 can be driven to rotate in a clockwise orientation, and/or one or more of the rollers 125, 129, 133 associated with the lower conveyor apparatus 121 can be driven to rotate in a counterclockwise orientation to cause the segments 123j, 123i, 123h, and 123g of the engaging members 123 of the upper conveyor apparatus 119 and the segments 131i, 131h, 131g, 131f, and 131e of the engaging members 131 of the lower conveyor apparatus 121 to generally move in the machine direction M to transfer blanks 71 through the system 100, as described further herein.

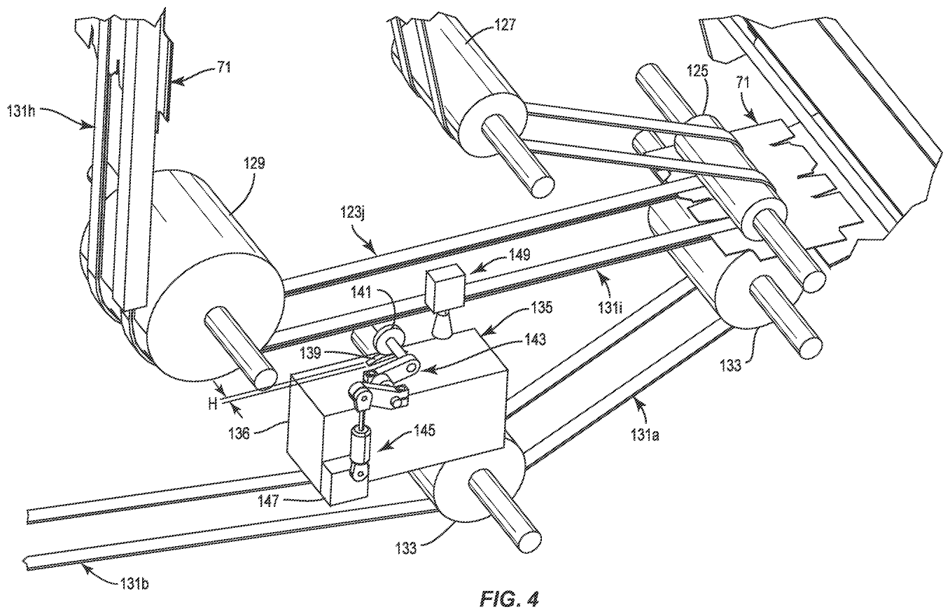

As shown in FIGS. 4 and 5, a coating applicator assembly 135 is supported proximate the segments 123j and 131i of the respective engaging members 123, 131 of the conveyor assembly 117. As shown, the coating applicator assembly 135 can include a coating container 136, e.g., a tank, bath, tray, or other container defining an interior reservoir 137, for holding a volume of a coating 86. As described above, the coating 86 can be a heat sealable fluid, e.g., so as to provide adhesive properties when exposed to a sufficient heat source.

A coating applicator wheel 139 can be supported at least partially in the interior of the reservoir 137 so as to be at least partially in contact with coating 86 held therein. The applicator wheel 139 can be rotatably disposed on a drive shaft, axle, spindle, etc., with a portion of the applicator wheel 139 exposed above the container 136, and, in one embodiment, can be configured to rotate such that a point along the outer surface of the applicator wheel 139 has a tangential speed substantially similar to those of the portions of the engaging members 123, 131 moving in the machine direction M.

The applicator wheel 139 can include one or more surface features, e.g., treads, tracks, ribs, grooves, etc. configured to engage and at least partially retain a quantity of the coating 86 as it rotates out of the reservoir 137 toward the engaging members 123, 131. In one embodiment, the applicator wheel 139 can be devoid of surface features, e.g., a generally smooth or unpatterned surface.

As also shown, a backup roller 141 is supported above the respective portions of the engaging members 123, 131. The backup roller 141 can be rotatably disposed on a bearing, shaft, axel, etc. In one embodiment, and as described further herein, the roller 141 can be configured to passively rotate upon engagement with a blank 71 moving thereby. In another embodiment, the roller 141 can be rotatably driven at a selected rotational speed.

The roller 141 can be mechanically coupled to a linkage 143 or other supporting member mounted to the container 136 and that is configured to support the roller 141. In one embodiment, the roller 141 can be raised and lowered via an actuator 145, e.g., a piston, pneumatic or hydraulic actuator, gearing system, etc., in mechanical cooperation with the linkage 143. In this regard, the roller 141 can be raised and lowered by the actuator 145, e.g., upon action of a motor 147 or other driving element. In one embodiment, the roller 141 can be supported at a preselected vertical position, and can be adjusted manually.

The roller 141 can be supported above the applicator wheel 139 at a vertical distance generally equivalent to the thickness of a blank 71. In one embodiment, the motor 147 can be operatively coupled to a sensor 149, e.g., a photosensor, photo eye, motion sensor, etc., that can be configured to receive a signal associated with the presence of an approaching blank 71, and, via one or more processors or controllers in electrical communication with the sensor 149, signal the motor 147 to drive the actuator 145 to raise or lower the roller 141 to a desired vertical distance relative to the applicator wheel 139. In this regard, and as described further herein, the roller 141 can be configured to raise and lower in response to an electrical signal received from the sensor 149, e.g., to adjust for the presence or absence of a blank 71 moving through the system 100. As described further herein, the roller 141 can be suitably positioned relative to the applicator wheel 139 so as to obviate the use of a sensor.

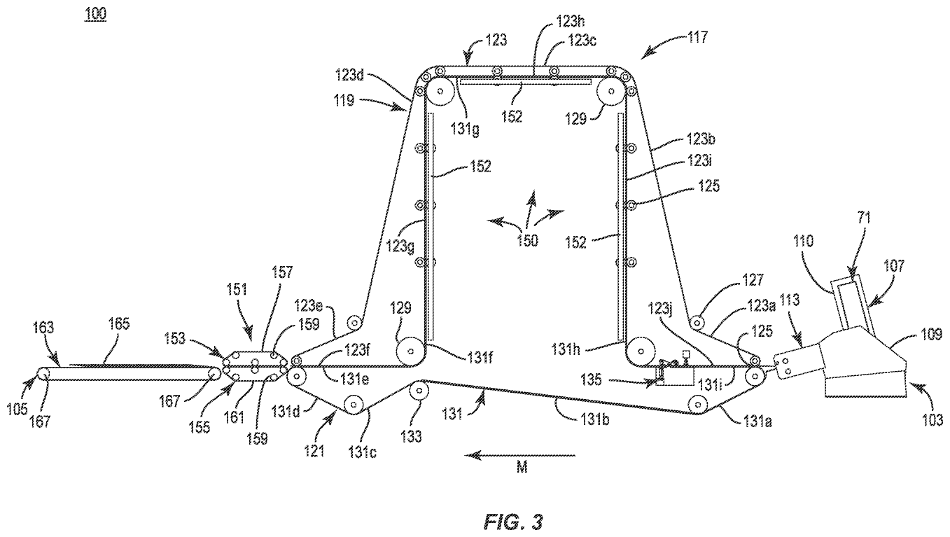

Still referring to FIGS. 2 and 3, a drying assembly 150 can be supported proximate the conveyor assembly 117. In the illustrated embodiment, the drying assembly 150 can be at least partially positioned between the upper conveyor apparatus 119 and the lower conveyor apparatus 121. In one embodiment, a drying member 152 can be supported proximate the segments 123i and 131h of the respective engaging members 123, 131, a drying member 152 can be supported proximate the segments 123h and 131g, and a drying member 152 can be supported proximate the segments 123g and 131f.

The drying members 150 can be, for example, one or more of air dryers, infrared heaters, radiative heaters, lamps, etc. configured to at least partially dry, reduce liquid pooling of etc., the coating 86 on the blanks 71 as applied by the coating applicator assembly 135. It will be understood that one or more of the drying members 152 can have a different configurations or arrangement without departing from the disclosure.

With continued reference to FIGS. 2 and 3, a metering station 151 can be positioned at/proximate a downstream end of the conveyor assembly 117, and can include an upper metering apparatus 153 and a lower metering apparatus 155.

The upper metering apparatus 153 can include a pair of parallel and spaced apart blank engaging members 157 having a configuration that can be similar to one or more of the blank engaging members 123, 131 of the conveyor assembly 117 described above. The engaging members 157 of the upper metering apparatus 153, as shown, can be provided in an at least partially looped configuration about a plurality of rollers that include rollers 159.

Similarly, the lower metering apparatus 155 can include a pair of parallel and spaced apart blank engaging members 161 having a configuration generally similar to the engaging members 157 described above and arranged about a plurality of rollers that include rollers 159. In this regard, and as shown, respective segments of the engaging members 157, are in overlapping, e.g., parallel and/or aligned, arrangement along a path parallel to the machine direction M. It will be understood that the respective engaging members 121, 131 can be in contact with one another at one or more portions, or, as described further herein, can be spaced apart either by predetermined alignment or the presence of one or more blanks 71 therebetween.

It will be understood that the upper metering apparatus 153 and the lower metering apparatus 155 can be selectively positioned and/or adjustable to provide a desired amount of spacing between respective segments of the engaging members 157, 161. It will be further understood that the rollers 159 can be supported and/or adjustable to a relative spacing so as to change or maintain a desired amount of tension on the engaging members 157, 161.

An exit conveyor apparatus 163, as shown, can be positioned at a downstream end of the metering station 151 for receiving blanks 71 exiting the metering station 151. The exit conveyor apparatus 163 can include a supporting surface 165, such as a bedplate, conveyor belt, etc., and one or more rollers 167 that can be driven, e.g., in a counterclockwise rotation, to move the supporting surface 165 in the machine direction M for further processing, e.g., at least partial folding, packaging/shipping, further treatment, etc.

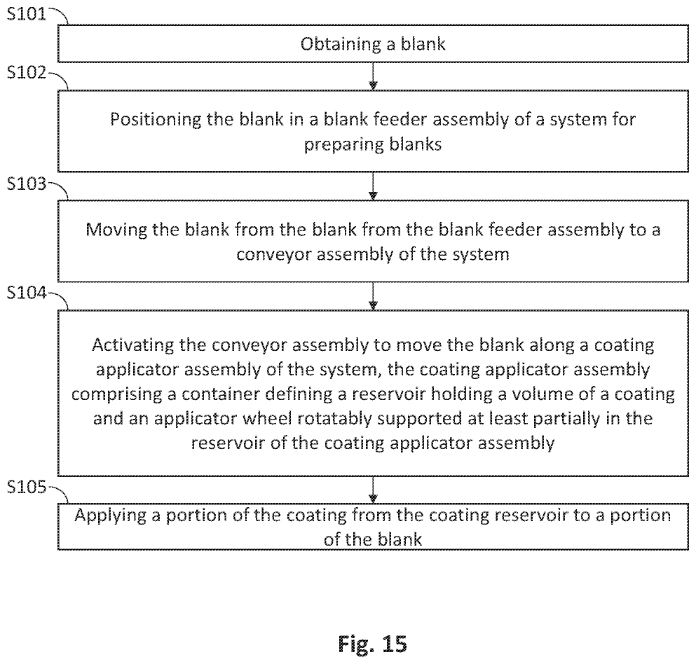

With continued reference to FIGS. 1-6, and with additional reference to FIG. 15, a method of preparing blanks 71 with the system 100 according to an exemplary embodiment of the disclosure will be described.

One or more blanks 71 can be obtained (step S101) and inserted into/positioned in the blank infeed 110 of the blank feeder assembly 107 (step S102), e.g., in a stacked configuration. In the illustrated embodiment, the blanks 71 can be positioned in the blank infeed 110 with the respective exterior surfaces 70 thereof facing downwardly to facilitate engagement with the coating applicator assembly 135, as described further herein. The distribution mechanism of the blank feeder assembly 107 can engage and serially distribute the blanks 71 into the rollers 115, such that the blanks 71 pass between the rollers 115, e.g., by driving of the rollers 115 and/or under the influence of gravity, to enter the conveyor assembly 117.

As shown, the blanks 71 can be fed into/moved to the conveyor assembly 117 from the blank feeder assembly 107 (step S103) in a manner so as to be spaced a distance D along the machine direction M. In this regard, the distribution mechanism of the blank feeder assembly 107 can be rotated at a suitable speed, e.g., via a controller that incorporates a timer or other stepped control and/or can be shaped or otherwise configured to engage and distribute blanks 71 with a predetermined distance D therebetween.

The conveyor assembly 117 can be activated (step S104) such that as the blanks 71 enter the conveyor assembly 117, e.g., between the blank engaging members 123, 131 at the respective overlapping segments 123j, 131i thereof such that the blanks 71 are at least partially engaged at respective exterior surfaces 70 thereof by the blank engaging members 131 of the lower conveyor apparatus 121 and at respective interior surfaces thereof by the blank engaging members 123 of the upper conveyor apparatus 119.

As the rollers 125, 127, 129, 133 rotate to carry the blanks 71 between the engaging members 121, 123 in the machine direction M (e.g., with the rollers 125, 127, 129 associated with the upper conveyor apparatus 119 driven to rotate in a clockwise direction as viewed from FIG. 3 and with the rollers 125, 129, 133 associated with the lower conveyor apparatus 121 driven to rotate in a counterclockwise direction as viewed from FIG. 3 as described above) , each successive blank 71 can be moved proximate the sensor 149 of the coating applicator assembly 135.

As the sensor 149 of the coating applicator assembly 135 registers the presence/approach of each blank 71, e.g., so that the blank 71 interrupts or trips the sensor 149, the sensor 149 can signal the motor 147 to drive the actuator 145 to position the linkage 143 and the roller 141 supported thereon to a vertical distance or height H suitable to engage the blank 71 as it passes between the roller 141 and the applicator wheel 139. In one embodiment, such a vertical gap H between the applicator wheel 139 and the roller 141 can be about equal to the thickness of the material of the blank 71.

With the blank 71 continuing along the machine direction M between the blank engaging members 121, 123, the exterior surface 70 of the blank 71 is positioned to be moved into rolling contact with the applicator wheel 139, which can be rotationally driven such that an outer surface thereof has a tangential speed substantially similar or equal to that of the speed of the blank 71 in the machine direction M. In this regard, as the blank 71 passes between the applicator wheel 139 and the roller 141, coating 86 is deposited on the outer surface of the applicator wheel 139 as it rotates through the reservoir 137 is transferred to the outer surface 70 of the blank 71 (S105). As described above, the blanks 71 can be arranged in the conveyor assembly 117 such that at least a portion of the coating 86 is applied to at least a portion of the attachment flap 80 of the blanks 71.

As described herein, the backup roller 141 is positioned for incidental rolling contact along the interior surface of the blank 71 opposite the applicator wheel 139, e.g., along the attachment flap 80 of the blank 71, so as to provide a counter or supporting force against contact with the applicator wheel 139 and the blank 71. In this regard, the roller 141 can be provided as supporting surface against which the blanks 71 can be pressed by engagement of the applicator wheel 139 with the blank to ensure consistent and effective contact between the applicator wheel 139 and the exterior surface 70 of the blank 71. Such an arrangement of the roller 141 and the applicator wheel 139 can minimize, inhibit, and/or prevent irregular applications of coating 86 to the blank 71, e.g., so as to avoid pools, puddles, gobs, otherwise undesirable applications of coating 86, etc. In this regard, it will be understood that a desired resistance to movement can be provided to the linkage 143 supporting the roller 141, e.g., so that the roller 141 maintains a preselected counterforce against the applicator wheel 139/blank 71 positioned therebetween.

In the illustrated embodiment, the blanks 71 can continue between the blank engaging members 123, 131 past the drying members 152 of the drying system 150. As described above, the drying members 152 can be one or more of air dryers, infrared heaters, radiative heaters, lamps, etc., which, upon activation, can be configured to at least partially dry, reduce liquid pooling of the coating 86 on the blanks 71 to further ensure a uniform application of the coating 86 on the blanks 71.

As the blanks 71 are carried to the downstream end of the conveyor assembly 117, the blanks 71 can enter the metering station 151. In the illustrated embodiment, the upper metering apparatus 153 and the lower metering apparatus 155 can have a relative configuration such that the rollers 159 associated with the upper metering apparatus 153 rotate at a different speed than the rollers 149 associated with the lower metering apparatus 155. In this regard, the blank engaging members 157 of the upper metering apparatus 153 can engage the blanks 71 at a different speed in the machine direction M than the blank engaging members 161 of the lower metering apparatus 155 so as to shift the relative positioning of blanks 71 disposed therealong. In one embodiment, and as shown, the distance D between the blanks 71 in the system can be reduced and/or eliminated such that blanks 71 exiting the metering station 151 are provided in an abutting and/or overlapping arrangement.

As described above, once the blanks 71 having been coated with the coating 86 as described above are deposited on the exit conveyor apparatus 163, the rollers 155 can be driven to move the supporting surface 165 and the blanks 71 supported thereon in the machine direction M for further processing, e.g., at least partial folding and/or erection of the blanks 71 into cartons. In one embodiment, such further processing can include folding the blanks into a collapsed, e.g., flattened or knocked down, configuration of a carton for shipping to a customer. Such folding of the blanks 71 can include adhering the attachment flap 80 of the blank 71 to the bottom panel 75 via the coating 86. In this regard, the coating 86 can have been at least partially activated by the drying apparatus 150 and/or can be subjected to further heating to prepare/activate the coating 86 for attachment of the attachment flap 80 to one or more other portions of the blank 71.

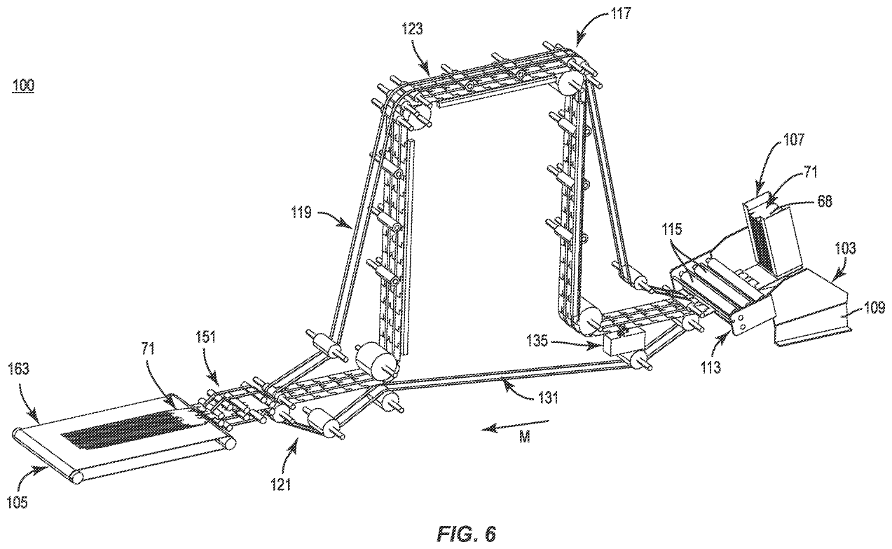

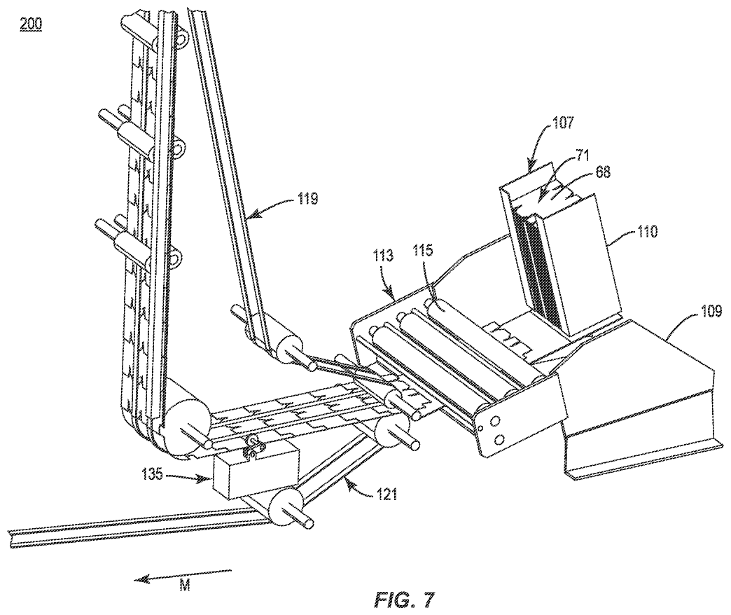

Turning to FIGS. 6 and 7, a method of preparing blanks 71 with the system 100 according to another exemplary embodiment of the disclosure is illustrated.

As shown in FIGS. 6 and 7, preparation/processing of the blanks 71 through the system 100 can proceed in a substantially similar manner to that described above, with the exception that the blanks 71 exit the blank feeder assembly 107 with a reduced or negligible/nonexistent distance D therebetween in the machine direction M. In this regard, the distribution mechanism of the blank feeder assembly 107 can be configured so as to distribute blanks 71 in a continuous manner, e.g., with no distance therebetween.

Such an arrangement of the blanks 71 through the system 100 may obviate the need for one or more other components thereof, for example, the sensor 149 associated with the coating applicator assembly 135 (as there will be no instances in which a blank 71 is not disposed between the roller 141 and the applicator wheel 139 so as to reduce or eliminate the need for relative adjustment therebetween). As another example, the metering station 151 could be removed or the blank engaging members 157 of the upper metering apparatus 153 could engage the blanks 71 at substantially the same speed in the machine direction M as the blank engaging members 161 of the lower metering apparatus 155 so as to maintain the relative positioning of blanks 71 disposed therealong.

In addition, such an arrangement of the blanks 71 through the system 100 more efficiently manage energy and resources, in one example, by maximizing the energy/power applied to the drying apparatus 150 such that no empty space between blanks 71 is subject to wasted heat.

As another example, the lack of any spacing/gapping between blanks 71 moving through the system 100 can reduce/eliminate any paths by which coating 86 could pass therethrough to contact an interior surface of one or more blanks 71, for example, instances in which the applicator wheel 139 is at a relatively high rate of rotational speed.

As described herein, the system 100 can be provided to apply the coating 86 to the blanks 71 for forming a collapsed, e.g., flattened or knocked down, configuration of a carton for shipping to a customer. Such a collapsed configuration of a carton formed from the blanks 71 can be provided with the coating 86 so as to avoid relatively thicker applications of adhesive such as glue that can be susceptible to formation of large globs or stickers that can interfere with transition of cartons formed from the blanks 71 from a collapsed configuration to an erected configuration. In one embodiment, a barrier coating on the blank 71 and the coating 86 can be selected from materials that provides one or more adhesive or adherable regions to the blanks 71 for formation of collapsed cartons that are free from polymeric material.

It will be understood that one or more of the rotational components, e.g., rollers of the system 100 described herein can be driven by a motor, engine, or other driving member/rotational actuator so as to impart a rotational force to such rollers. It will be further understood that any such motors or driving members can be connected to other portions of the system 100 via a driveshaft, gearing, mechanical transmission, etc.

It will be understood that one or more components of the system 100 can have a different configuration, position, arrangement, etc., without departing from the disclosure.

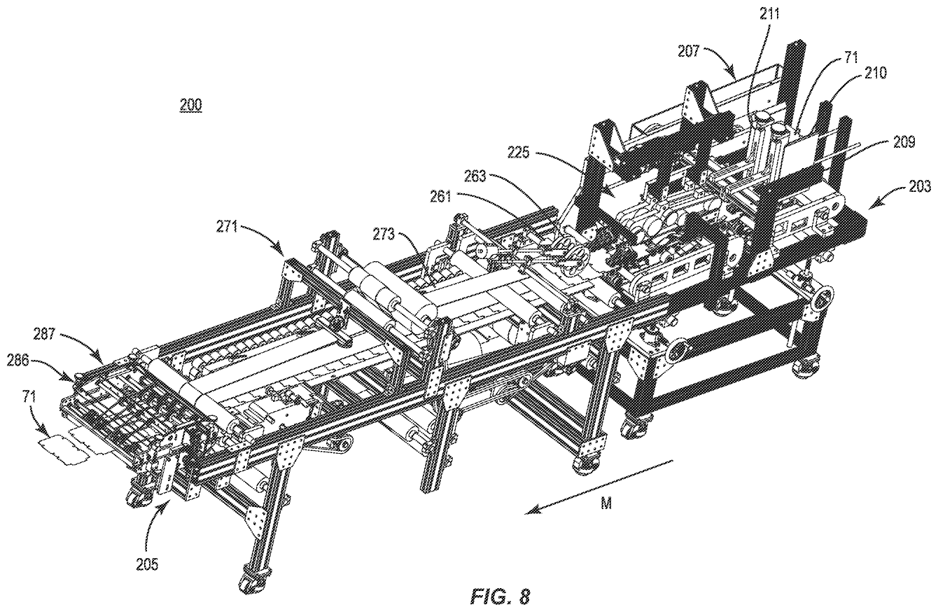

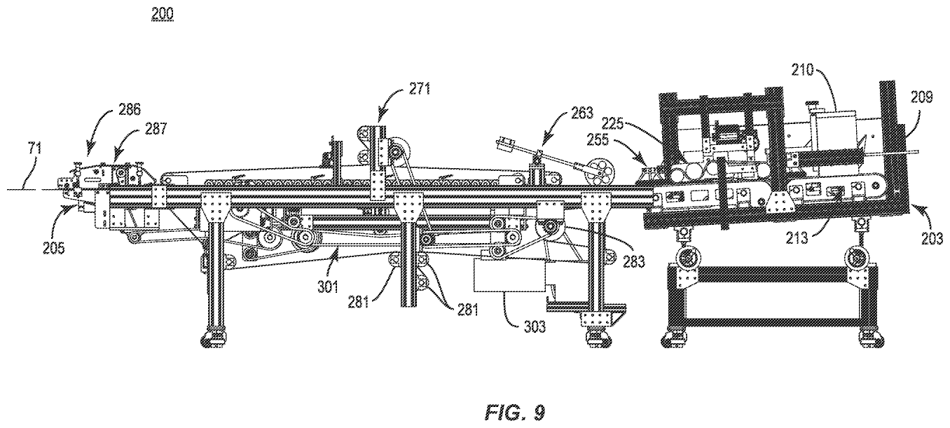

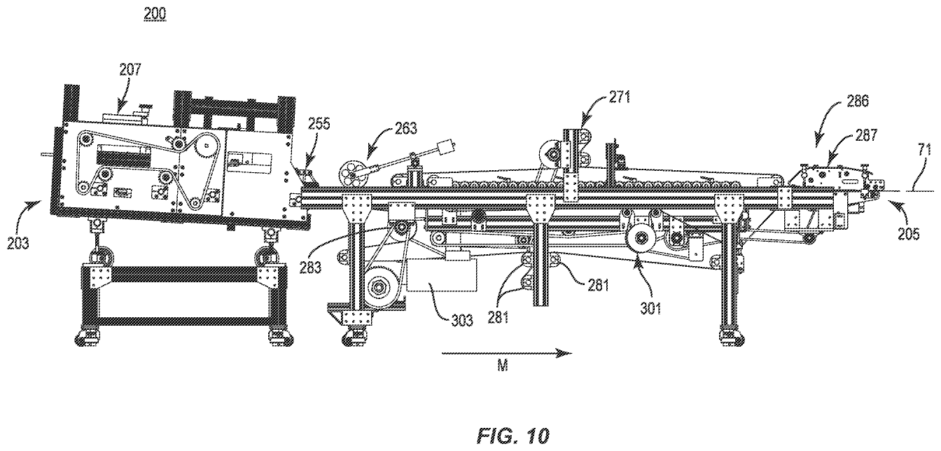

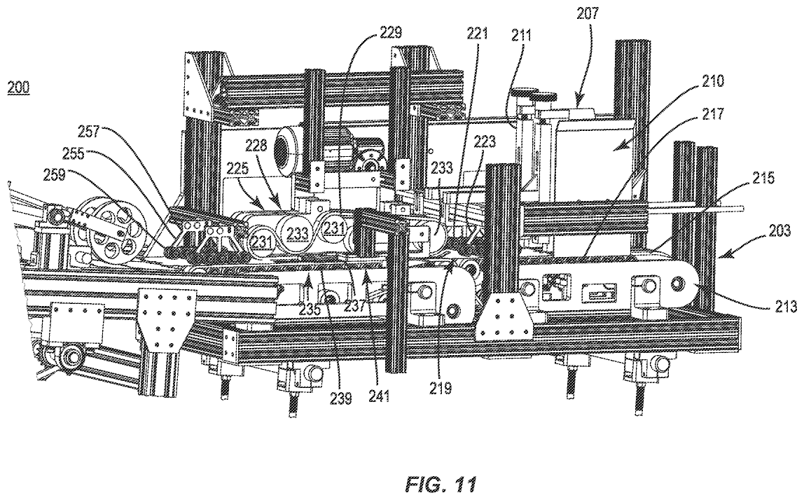

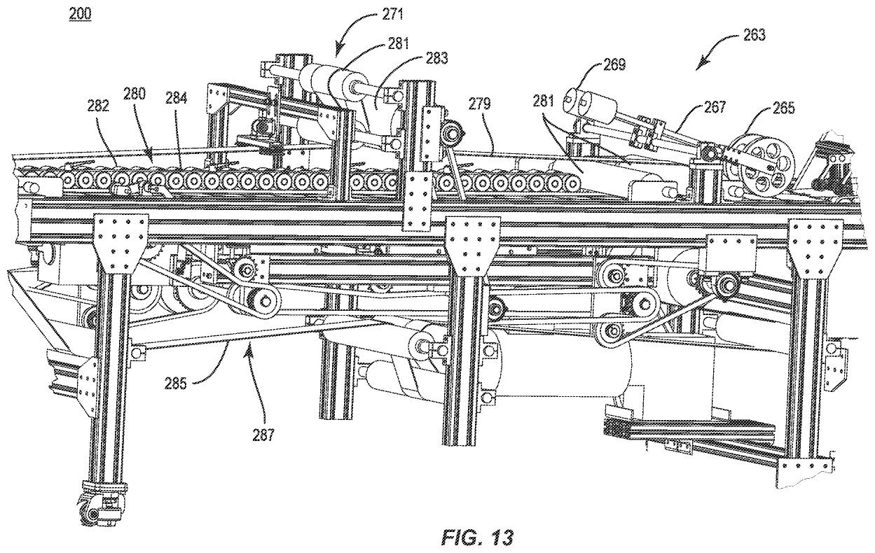

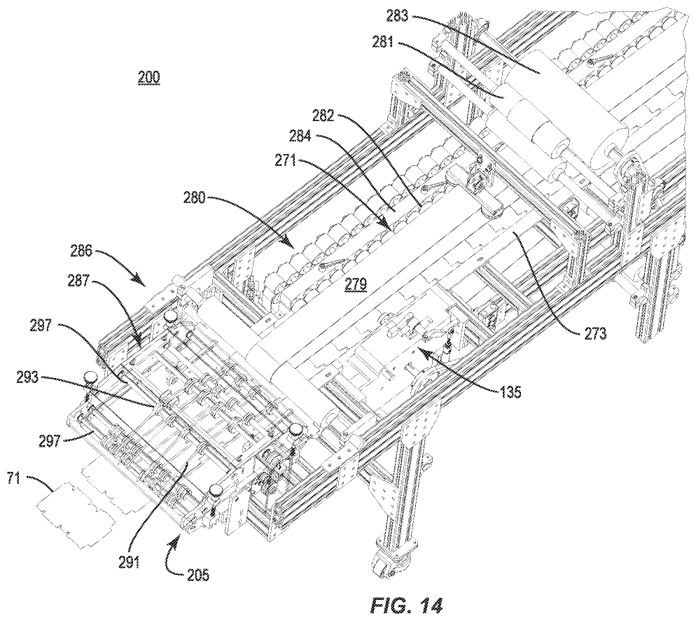

Turning to FIGS. 8-14, a system for preparing/processing the blanks 71 according to a second exemplary embodiment of the disclosure is generally designated 200. The system 200 can have one or more components similar to those described above with respect to the system 100 according to the first exemplary embodiment, and like or similar features are designated with like or similar reference numerals.

As shown, the system 200 can have an upstream end 203 and a downstream end 205, with the machine direction M of the system 200 defined in the direction from the upstream end 203 to the downstream end 205. The system 200 can be configured to prepare/process blanks 71, though differently configured blanks can be used with the system 200 without departing from the disclosure.

The system 200 can include a blank feeder assembly 207 proximate the upstream end 203 thereof for receiving and sequentially distributing blanks 71 in the machine direction M of the system 200. As shown, the blank feeder assembly 207 can include a housing/base 209 that supports a blank infeed 210 for receiving one or more of the blanks 71. As shown, the blank infeed 210 can have a chute or hopper-like configuration for receiving the stacked blanks 71.

One or more blank metering gates 211 can be adjustably positioned in front of the blank infeed 210 such that the blank metering gates 211 block forward motion of the blanks 71 out of the blank infeed 210. In this regard, the blank metering gates 211 can be vertically adjusted relative to the blank infeed 210 to provide a preselected clearance at the bottom of the blank infeed 210 for a single blank 71 to exit the blank infeed 210 in a forward direction, e.g., the machine direction M. For example, the blank metering gates 211 can be raised above a bottom end of the blank infeed 210 a distance approximately corresponding to a thickness of the blank 71 such that blanks 71 stacked above the lowermost blank 71 are inhibited from forward motion by the blank metering gates 211.

A blank distribution mechanism 213 can be positioned in communication with a bottom or exit end of the blank infeed 210. In the illustrated embodiment, the blank distribution mechanism 213 can include one or more blank engaging members 215 positioned below the blank infeed 210 and looped or otherwise disposed about a plurality of rollers 217. As described further herein, the blank engaging members 215 can support and move the blanks 71 in the machine direction M.

An upstream roller assembly 219, as shown, can be supported above the blank engaging members 215, and can include a plurality of rollers 221 rotatably mounted on a spaced apart pair of overhead supports 223 for engaging blanks 71 moving therebelow.

Positioned downstream from the upstream roller assembly 219 is a blank folding assembly 225 that includes an upper conveyor apparatus 228 comprising a plurality of blank engaging members 229 wrapped/disposed about a series of rollers 231, 233 and arranged for engagement with blanks 71 passing therebelow.

The blank folding assembly 225 also includes a lower conveyor apparatus 235 that includes a plurality of blank engaging members 237 arranged about a series of rollers 239 such that when the rollers 239 are rotated, the blank engaging members 237 move the blanks 71 in the machine direction M.

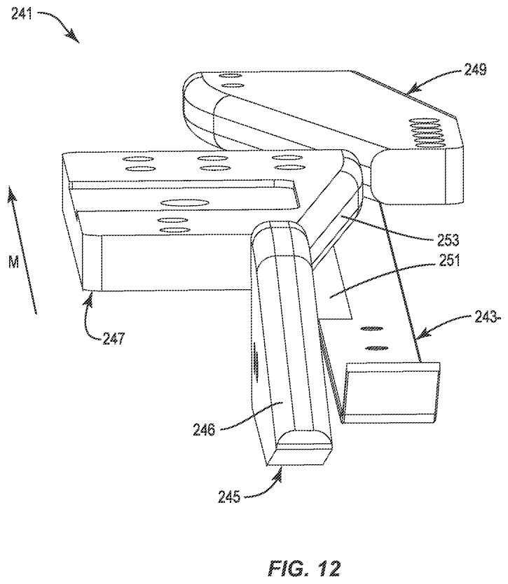

Positioned adjacent the upstream roller assembly 227 and the lower conveyor apparatus 235 of the blank folding assembly 225 is a folding apparatus 241 that includes a forming rail 243 positioned above the blank engaging members 237 and cam blocks 245, 247, 249 having a plurality of blank engaging surfaces. As shown in FIG. 12, the cam block 245 defines an upwardly sloping surface 246 with a downstream end positioned adjacent a beveled surface 251 along the forming rail 243. The cam block 245 intersects the cam block 247, which defines an inwardly sloping surface 253 above the beveled surface 251 and extending downstream toward the cam block 249.

Downstream from the blank folding assembly 225, a downstream roller assembly 255 can be positioned overhead of downstream portions of the blank engaging members 237. The downstream roller assembly 255 can include a pair of spaced apart supports 257 and a plurality of rollers 259 rotatably mounted to the support 257.

An idler roller 261 can be positioned downstream from the overhead roller assembly 255 to carry blanks 71 into engagement with an upstream metering assembly 263. The upstream metering assembly 263 can include a pair of spaced apart metering wheels 265 rotatably mounted on an upstream end of the frame 267, with counterweights or ballasts 269 mounted on a downstream end of the frame 267.

With continued reference to FIGS. 8-14, the metering assembly 263 can be positioned above an upstream portion of a conveyor assembly 271 that includes a bedplate 273, an upper conveyor apparatus 275 positioned over the bedplate 273, and a lower conveyor apparatus 277 extending over a portion of and below the bedplate 273.

The upper conveyor apparatus 275 of the conveyor assembly 271 can include a blank engaging member 279 disposed about a series of rollers 281, 283 and having a lower portion positioned for engaging blanks 71 disposed on the bedplates 273.

Similarly, the lower conveyor apparatus 277 of the conveyor assembly 271 can include a blank engaging member 285 disposed about a series of rollers 281, 283, with an upper portion of the blank engaging member 285 positioned on the upper surface of the bedplate 273.

Positioned adjacent a downstream portion of the conveyor assembly 271 is the coating applicator assembly 135. As described further herein, the coating applicator assembly 135 is positioned and configured to apply a coating to the blanks 71 moving along the conveyor assembly 271.

As also shown, a conveyor roller apparatus 280 can be positioned along a portion of the conveyor assembly 271 opposite the coating applicator assembly 135, and can include a plurality of rollers 282 rotatably mounted on a support 284 positioned adjacent the bedplate 273.

A downstream metering station 286 comprising a metering assembly 287 can be positioned adjacent the downstream end 205 of the system 200. In the illustrated embodiment, the downstream metering assembly 287 can include a conveyor apparatus 289, e.g., a belt moving along rollers, for supporting and moving the blanks 71 downstream. A plurality of blank engaging members 291 can be arranged within tracks defined in pulleys 293, 295 that are rotatably disposed about respective idler shafts 297, 299.

It will be understood that one or more of the rotational components, e.g., rollers, pulleys, gears, belts, etc. of the system 200 described herein can be driven by one or more driving members/rotational actuators, e.g., one or more motors 301 so as to impart a rotational force to such components. It will be further understood that any such motors or driving members can be connected to other portions of the system 200 via a mechanical transmission 303 including one or more of drive shafts, gearing/gearboxes, couplings, etc.

With continued reference to FIGS. 8-14, and with additional reference to FIG. 15, a method of preparing a blank 71 for forming a carton with the system 200 will be described according to an exemplary embodiment of the disclosure.

One or more blanks 71 can be obtained (step S101) and inserted into/positioned in the blank infeed 210 of the blank feeder assembly 207 (step S102), e.g., in a stacked configuration as shown. In the illustrated embodiment, the blanks 71 can be positioned in the blank infeed 210 with the respective exterior surfaces 70 thereof facing downwardly to facilitate engagement with the coating applicator assembly 135, as described further herein.

In one exemplary embodiment, the stack of blanks 71 can be gravity fed downwardly through the blank infeed 210 such that a lowermost blank 71 is positioned to contact the blank engaging members 215 of the blank distribution mechanism 213. Accordingly, as the rollers 217 of the blank distribution mechanism 217 are driven to rotate, the blank engaging members 215 can carry a blank 71 forwardly in the downstream direction M. It will be understood that the blank metering gates 211 can be positioned above a lower end of the blank infeed 210 a distance sufficient to inhibit/prevent movement of blanks 71 positioned above the lowermost blank 71 until the lowermost blank 71 has exited the blank feeder assembly 207. In this regard, blanks 71 can be serially distributed from the blank feeder assembly 207 in an abutting or spaced apart arrangement (step S103).

As the blank 71 is carried by the blank engaging members 215 in the downstream direction M, the blank 71 can pass underneath the rollers 221 of the upstream roller assembly 219. The supports 223 of the upstream roller assembly 219 can be mounted such that the rollers 221 are positioned for at least partial rolling contact with the blank 71 as it passes thereby, for example, to maintain proper alignment and orientation of the blank 71 on the blank engaging members 215.

As the blank 71 continues to advance, they move into the blank folding assembly 225. In one embodiment, the blank is transferred between the blank engaging members 229, 237 of the respective upper conveyor apparatus 228 and the lower conveyor apparatus 235 of the blank folding apparatus 225. The rollers 231, 233, 239 can be driven to rotate such that the blank engaging members 229, 237 move the blank 71 in the downstream direction M along the folding apparatus 241.

In one embodiment, the blank 71 can be positioned such that a portion of the second side panel 79 is positioned in sliding contact below the forming rail 243. Upon continued advancement in the downstream direction M, the attachment flap 80 of the blank 71 engages upwardly sloping surface 246 of the cam block 245 and slides therealong until a portion of the attachment flap 80 contacts the inwardly sloping surface 253 of the cam block 247, which causes the attachment flap 80 to at least partially fold about the fold line 72 toward the forming rail 243. Such folding of the attachment flap 80 can be facilitated by the beveled surface 251 of the forming rail 243. Continued movement of the blank 71 in the downstream direction M can cause the attachment flap 80 to contact the cam block 249 and to continue moving downward toward the second side panel 79 such that the attachment flap 80 passes underneath the cam block 249. In one embodiment, the cam block 249 can be positioned above the blank 71 so as to at least partially compress the attachment flap 80 against a portion of the forming rail 243, e.g., to further weaken/form (broadly, “pre-break” the fold line 72.

The aforementioned pre-breaking of the fold line 72 is such that the attachment flap 80 is readily foldably at the fold line 72 relative to the remainder of the blank 71 for ease and efficiency of manipulation of later carton forming processes.

Upon disengagement with the folding apparatus 241, the blank 71 can continue along a portion of the lower conveyor apparatus 235 over which the upper conveyor apparatus 228 is not coextensive. As shown, the downstream roller assembly 255 can be supposed over the blank engaging members 237, with the supports 257 mounted so as to hold the rollers 259 in at least partial rolling contact with the blank 71 passing underneath, for example, to maintain proper alignment and orientation of the blank 71 on the blank engaging members 237.

After the blank 71 passes through the blank folding assembly 225, the blank 71 can advance over the idler roller 261 and onto the bedplate 273/blank engaging members 285 proximate the upstream metering assembly 263. The upstream metering assembly 263 can be arranged such that the metering wheels 265 exert a downward force on the blank 71 that momentarily inhibits forward motion of the blank 71 in the downstream direction so that a trailing blank 71 being processed through the system 71 exits the blank folding assembly 225 and moves into at least partially overlapping engagement with the leading blank 71. Accordingly, the ballasts 269 can be weighted/lightened such to provide a desired downward force on the blank(s) 71 positioned beneath the metering wheels 265. In one embodiment, the metering wheels 265 can have a preselected resistance to rotation to provide a force on the blank(s) 71 with a component in the upstream direction to further inhibit forward motion of the blank(s) 71 in the downstream direction M. It will be understood that, as blanks 71 are accumulating below the metering wheels 265, the blank engaging members 285 may be driven to slide along the surface of the blank(s) 71.

In this regard, the upstream metering assembly 263 can be configured so as to allow a plurality of at least partially overlapping blanks 71 to accumulate below/proximate the metering wheels 265 before the metering wheels 265 are urged to rotate and allow the blanks 71 to advance in the machine direction M. In one embodiment, the blank(s) 71 can at least partially slide along the surface of the metering wheels 265 as they pass thereby.

Upon moving past the metering wheels 265, each blank 71 can be positioned between the blank engaging members 279, 285 of the respective upper conveyor apparatus 275 and lower conveyor apparatus 277 of the conveyor assembly 271. The rollers 281, 283 can be driven such that the blank 71 is further advanced in the downstream direction M between the blank engaging members 279, 285, and at least partially supported by the bedplate 273 (step S104).

Marginal portions of the blank(s) 71 can also be engaged between the upper and lower rollers 282 of the conveyor roller apparatus 280 as the blank(s) 71 continued through the conveyor assembly 271, for example, for example, to maintain proper alignment and orientation of the blank(s) 71 relative to the bedplate 273.

With the blank(s) 71 continuing along the machine direction M between the blank engaging members 279, 285 of the conveyor apparatus 271, the exterior surface 70 of the blank 71 is positioned for rolling contact with the applicator wheel 139, which can be rotationally driven such that an outer surface thereof has a tangential speed substantially similar or equal to that of the speed of the blank 71 in the machine direction M. In this regard, and as described above with regard to the system 100, as the blank 71 passes between the applicator wheel 139 and the backup roller 141, coating 86 is deposited on the outer surface of the applicator wheel 139 as it rotates through the reservoir 137 is transferred to the outer surface 70 of the blank 71. As described above, the blanks 71 can be arranged in the conveyor assembly 117 such that the coating 86 is applied to at least a portion of the attachment flap 80 of the blanks 71 (step S105).

The system 200 can be arranged such that the at least partially abutting/overlapping arrangement of the blanks 71 is such to obviate the need for a sensor, e.g., the sensor 149, to time the selective contact of the backup roller 141 with the blanks 71, since the blanks 71 are provided in a substantially continuous fashion that is conducive to substantially continuous application of coating 86 by the applicator wheel 139. As described above, the lack/minimization of any spacing/gapping between blanks 71 moving through the system 200 can reduce/eliminate any paths by which coating 86 could pass therethrough to contact an interior surface of one or more blanks 71, for example, instances in which the applicator wheel 139 is at a relatively high rate of rotational speed. In one embodiment, one or more sensors associated with vertical adjustment of the backup roller 141 can be provided.

In the illustrated embodiment, the coating 86 can be selected to obviate the need for a drying assembly as described above with regard to the system 100. For example, the coating 86 can be provided with a configuration with relatively fast drying time, to quickly dry when exposed to air, etc. In this regard, the coating 86 can be selected as a coating other than a heat seal coating, though the coating 86 can be at least partially heat sealable without departing from the disclosure.

As the blanks 71 pass the coating applicator assembly 135 and exit the conveyor assembly 271, the blanks 271 can advance in the downstream direction M into the metering station 286/downstream metering assembly 287 to be positioned between the conveyor apparatus 289 and the blank engaging members 291.

As the blanks 71 are carried to the downstream end of the conveyor assembly 117, the blanks 71 can enter the metering station 151.

In one embodiment, one or more of the pulleys 293, 295 or idler shafts 297, 299 can be rotated at a different rotational speed than the conveyor apparatus 289 so as to shift the relative positioning of blanks 71 disposed therealong, e.g., to provide the blanks 71 provided in an abutting and/or overlapping arrangement. Such metering of the blanks 71 can be performed, for example, due to incidental or relative shifting of blanks 71 through the conveyor assembly 271.

In another embodiment, one or more of the pulleys 293, 295 or idler shafts 297, 299 can be rotated such that the portion of the blank engaging members 291 in contact with the blanks 71 can exert a force thereon in an upstream direction to at least partially separate blanks 71 along the machine direction M., e.g., to facilitate further processing of the blanks 71. In another embodiment, the engaging members 291 can be statically engaged with the blanks 71, e.g., not rotating, to cause separation of the blanks 71 as described above.

As described herein, the system 200 can be provided to apply the coating 86 to the blanks 71 for forming a collapsed, e.g., flattened or knocked down, configuration of a carton for shipping to a customer. Such a collapsed configuration of a carton formed from the blanks 71 can be provided with the coating 86 so as to avoid relatively thicker applications of adhesive such as glue that can be susceptible to formation of large globs or stickers that can interfere with transition of cartons formed from the blanks 71 from a collapsed configuration to an erected configuration. In one embodiment, a barrier coating on the blank 71 and the coating 86 can be selected from materials that provides one or more adhesive or adherable regions to the blanks 71 for formation of collapsed cartons that are free from polymeric material.

As described herein, the blank engaging members can have a generally elongate configuration, e.g., bands, belts, plates, rods, etc. It will be understood that one or more of such engaging members can be continuous members, or can be formed of multiple jointed segments. In one embodiment, one or more of the blank engaging members can be formed of a stretchable material, e.g., an elastomeric material or otherwise elastically deformable and/or resilient material.

It will be understood that one or more components of the system 100 can have a different configuration, position, arrangement, etc., without departing from the disclosure.

It will also be understood that one or more of the components of the systems described herein can have a different configuration without departing from the disclosure. It will be further understood that suitable supporting structures (e.g., bases, legs, platforms, supports, braces, etc.) can be provided to support and facilitate operation of the various components described herein.

In general, the blanks of the present disclosure may be constructed from paperboard having a caliper so that it is heavier and more rigid than ordinary paper. The blank can also be constructed of other materials, such as cardboard, or any other material having properties suitable for enabling the construct to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

The foregoing description of the disclosure illustrates and describes various embodiments.

As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A method of preparing a blank for forming a carton, the method comprising;
obtaining a blank;
positioning the blank in a blank feeder assembly of a system for preparing blanks;
moving the blank from the blank feeder assembly to a conveyor assembly of the system;
activating the conveyor assembly to move the blank along a coating applicator assembly of the system, the coating applicator assembly comprising a container defining a reservoir holding a volume of a coating and an applicator wheel rotatably supported at least partially in the reservoir of the coating applicator assembly; and
applying a portion of the coating from the reservoir to a portion of the blank.

2. The method of claim 1, wherein the applying a portion of the coating comprises moving the blank into contact with the applicator wheel.

3. The method of claim 2, wherein a portion of the applicator wheel is exposed above the container.

4. The method of claim 3, wherein the method further comprises driving the wheel to rotate through the reservoir.

5. The method of claim 4, wherein the applying a portion of the coating comprises positioning a portion of the blank between the applicator wheel and a backup roller mounted to the container of the coating applicator assembly.

6. The method of claim 5, wherein the method further comprises adjusting a height of the backup roller relative to the applicator wheel.

7. The method of claim 6, wherein the backup roller is mounted to the container with a linkage, and wherein the adjusting the height of the backup roller comprises driving an actuator to move the linkage to position the backup roller at a preselected height relative to the applicator wheel in response to a signal from a sensor.

8. The method of claim 7, wherein the sensor is a photosensor, and the method further comprises moving the blank proximate the photosensor to send a signal from the photosensor to the actuator.

9. The method of claim 2, wherein the system has an upstream end and a downstream end, the blank infeed assembly is positioned proximate the upstream end of the system, the conveyor assembly is positioned downstream from the blank infeed assembly, and the coating applicator assembly is positioned along a portion of the conveyor assembly.

10. The method of claim 9, wherein a drying assembly is positioned downstream from the coating applicator, the drying assembly comprising at least one drying member.

11. The method of claim 10, wherein the method further comprises activating the at least one drying member to at least partially dry coating disposed on the blank.

12. The method of claim 9, wherein the system further comprises a metering station assembly positioned downstream from the coating applicator assembly, the metering station comprising at least one blank engaging member positioned for contact with the blank.

13. The method of claim 9, wherein a blank folding assembly is positioned along a portion of the conveyor assembly, the blank folding assembly comprising a folding rail and at least one cam block.

14. The method of claim 13, wherein the method further comprises sliding a portion of the blank along the forming rail such that a portion of the blank contacts a surface of the cam block and at least partially folds over the forming rail.

15. A system for preparing blanks for forming cartons, the system comprising;
a blank feeder assembly positioned proximate an upstream end of the system for distributing at least one blank therefrom;
a conveyor assembly positioned downstream from the blank feeder assembly and comprising at least one blank engaging member for contacting and moving the at least one blank in a downstream direction of the system; and
a coating applicator assembly positioned along a portion of the conveyor assembly, the coating applicator assembly comprising a container defining a reservoir holding a volume of a coating and an applicator wheel rotatably supported at least partially in the reservoir of the coating applicator assembly.

16. The system of claim 15, wherein a portion of the applicator wheel is exposed above the container.

17. The system of claim 16, wherein the coating applicator assembly further comprises a backup roller mounted to the container of the coating applicator assembly, the backup roller is positioned above the applicator wheel for at least partially receiving the at least one blank therebetween.

18. The system of claim 17, wherein the backup roller is mounted to the container with a linkage, and the coating applicator assembly further comprises an actuator mechanically coupled to the linkage and operable to move the linkage.

19. The system of claim 18, wherein the coating applicator assembly further comprises a sensor in electrical communication with a motor, the motor is operable to drive the actuator in response to a signal from the sensor.

20. The system of claim 19, wherein the sensor is a photosensor configured to send a signal to the motor when the at least one blank moves proximate the sensor.

21. The system of claim 15, wherein the system has an upstream end and a downstream end, the blank infeed assembly is positioned proximate the upstream end of the system, the conveyor assembly is positioned downstream from the blank infeed assembly, and the coating applicator assembly is positioned along a portion of the conveyor assembly.

22. The system of claim 21, wherein the system further comprises a drying assembly positioned downstream from the coating applicator, the drying assembly comprising at least one drying member configured to at least partially dry coating disposed on the at least one blank.

23. The system of claim 21, wherein the system further comprises a metering station positioned downstream from the coating applicator assembly, the metering station comprising at least one blank engaging member positioned for contact with the at least one blank.

24. The system of claim 21, wherein a blank folding assembly is positioned along a portion of the conveyor assembly, the blank folding assembly comprising a folding rail and at least one cam block for folding at least a portion of the at least one blank.

25. A coating applicator assembly for applying coating to at least one blank, the coating applicator assembly comprising:
a container defining a reservoir holding a volume of a coating; and
an applicator wheel rotatably supported at least partially in the reservoir of the coating applicator assembly, the applicator wheel positioned for contacting at least one blank moving thereby to apply at least a portion of the coating in the reservoir to at least a portion of the at least one blank.

26. The coating applicator assembly of claim 25, wherein a portion of the applicator wheel is exposed above the container.

27. The coating applicator assembly of claim 26, further comprising a backup roller mounted to the container, the backup roller is positioned above the applicator wheel for at least partially receiving the at least one blank therebetween.

28. The coating applicator assembly of claim 27, wherein the backup roller is mounted to the container with a linkage, and the coating applicator assembly further comprises an actuator mechanically coupled to the linkage and operable to move the linkage.

29. The coating applicator assembly of claim 28, wherein the coating applicator assembly further comprises a sensor in electrical communication with a motor, the motor is operable to drive the actuator in response to a signal from the sensor.

30. The coating applicator assembly of claim 29, wherein the sensor is a photosensor configured to send a signal to the motor when the at least one blank moves proximate the sensor.
